(19) United States
(12) Patent Application Publication
(10) Pub. No.: US 2025/0323251 A1
(43) Pub. Date: Oct. 16, 2025

(54) NEGATIVE ACTIVE MATERIAL, METHOD OF PREPARING NEGATIVE ACTIVE MATERIAL, NEGATIVE ELECTRODE INCLUDING NEGATIVE ACTIVE MATERIAL, AND RECHARGEABLE LITHIUM BATTERY INCLUDING NEGATIVE ACTIVE MATERIAL

(71) Applicant: SAMSUNG SDI CO., LTD., Yongin-si (KR)

(72) Inventors: Doori OH, Yongin-si (KR); Youngugk KIM, Yongin-si (KR); Deok-Hyun KIM, Yongin-si (KR); Eunji KANG, Yongin-si (KR); Banseok LEE, Yongin-si (KR); Yookyung KIM, Yongin-si (KR); Chul YOUM, Yongin-si (KR)

(21) Appl. No.: 19/176,363

(22) Filed: Apr. 11, 2025

(30) Foreign Application Priority Data
Apr. 11, 2024 (KR) 10-2024-0048823

(51) Int. Cl. H01M 4/36; H01M 4/48; H01M 4/587; H01M 10/052

(52) U.S. Cl. CPC H01M 4/366; H01M 4/48; H01M 4/587; H01M 10/052

(57) ABSTRACT

Disclosed are a negative active material, a method of preparing the negative active material, and a rechargeable lithium battery including the negative active material. The negative active material includes a core comprising a porous support comprising pores, a carbon layer provided in the pores, a silicon layer provided on the carbon layer, and an amorphous carbon layer provided on an outer surface of the core. The pores comprise mesopores that are about 50% to about 100% of a total porosity of the porous support.

### CROSS-REFERENCE TO RELATED APPLICATION

This application claims priority to and the benefit of Korean Patent Application No. 10-2024-0048823 filed in the Korean Intellectual Property Office on Apr. 11, 2024, the entire contents of which are incorporated herein by reference.

### BACKGROUND

### (a) Field

Embodiments relate to a negative active material, a method of preparing the negative active material, a negative electrode including the negative active material, and a rechargeable lithium battery including the negative active material.

### (b) Description of the Related Art

With the rapid spread of electronic devices that use batteries such as mobile phones, laptop computers, and electric vehicles, a demand for smaller, lighter, and relatively high-capacity rechargeable lithium batteries has rapidly increased. Improving the performance of rechargeable lithium batteries has therefore been considered.

Rechargeable lithium batteries include a positive electrode and a negative electrode including an active material capable of intercalating and deintercalating lithium ions, and an electrolyte solution. Electrical energy is produced by oxidation and reduction reactions when lithium ions are intercalated/deintercalated at the positive and negative electrodes.

### SUMMARY

One or more embodiments provide a negative active material exhibiting high-capacity, high efficiency, and excellent cycle-life characteristic.

Another embodiment provides a method of preparing the negative active material.

Still another embodiment provides a negative electrode including the negative active material.

Still another embodiment provides a rechargeable lithium battery including the negative active material.

One or more embodiments provide a negative active material including a core including a porous support including pores; a carbon layer provided in the pores, a silicon layer provided on the carbon layer; and an amorphous carbon layer provided on an outer surface of the core, wherein the pores include mesopores that are about 50% to about 100% of a total porosity of the porous support.

Another embodiment provides a negative active material including secondary particles that are an agglomeration of primary particles; wherein the primary particles include (i) a core including a porous support including pores, (ii) a carbon layer provided in the pores, (iii) a silicon layer provided on the carbon layer; and (iv) an amorphous carbon layer provided on an outer surface of the core, wherein the pores include mesopores that are about 50% to about 100% of a total porosity of the porous support.

Still another embodiment provides a method of preparing a negative active material including first vapor coating on a porous support including pores with a carbon gas to form a carbon layer in the pores; second vapor coating on the carbon layer with a silicon gas to form a silicon layer; and coating an outer surface of the porous support with an amorphous carbon precursor, wherein the pore include mesopore that are about 50% to about 100% of a total porosity of the porous support.

Still another embodiment provides a rechargeable lithium battery including a negative electrode including the negative active material; a positive electrode; and an electrolyte.

A negative active material according to one or more embodiments may exhibit excellent charge and discharge efficiency, high-rate characteristic, and excellent cycle-life characteristic.

### BRIEF DESCRIPTION OF THE DRAWINGS

FIG. 1 is a schematic view showing the negative active material according to embodiments.

FIG. 2 to FIG. 5 are cross-sectional views schematically showing rechargeable lithium batteries according to embodiments.

### DETAILED DESCRIPTION

Embodiments are described herein in detail. However, the embodiments are exemplary, and the present disclosure is not limited to the disclosed embodiments.

Terms used in this specification explain embodiments but are not intended limit the full scope of the present disclosure. Expressions in the singular include expressions in plural unless the context clearly dictates otherwise.

The term “combination thereof” may include a mixture, a laminate, a complex, a copolymer, an alloy, a blend, a reactant of constituents.

The term “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not precluded.

The drawings show thicknesses enlarged in order to clearly show the various layers and regions, and the same reference numerals are given to similar parts throughout the specification. If an element, such as a layer, a film, a region, a plate, or the like is referred to as being “on” or “over” another part, it may include cases where it is “directly on” another element, but also cases where there is another element in between. In contrast, when an element is referred to as being “directly on” another element, there are no intervening elements present.

Herein, “layer” includes a shape totally formed on the entire surface or a shape partial surface, when viewed from a plane view.

Herein, “or” is not to be construed as an exclusive meaning, for example, “A or B” is construed to include A, B, A+B, and the like.

As used herein, when a definition is not otherwise provided, a particle diameter or a particle size may be an average particle diameter. The average particle diameter indicates an average value of the diameter of the particles depending on a cumulative volume in the particle size distribution of particles included in the negative active material. The average particle size (D50) may be measured by a method well known to those skilled in the art, for example, by a particle size analyzer, or by a transmission electron microscopic image, or a scanning electron microscopic image. In some embodiments, a dynamic light-scattering measurement device is used to perform a data analysis, and the number of particles is counted for each particle size range, and from this, the average particle diameter (D50) value may be easily obtained through a calculation.

The particle size may be measured by a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of about 60 W, and calculating an average particle diameter (D50) in the 50% standard of particle distribution in the measuring device.

In some embodiments, an average particle diameter may be measured by various techniques such as, for example, by a particle analyzer.

In some embodiments, a thickness may be measured by a scanning electron microscope (SEM) or a transmission electron microscope (TEM) image for the cross-section. But the present disclosure is not limited to thickness measurement by SEM and TEM, and thickness may be measured by any other techniques known in the related arts. The thickness may be an average thickness.

As used herein, soft carbon refers to graphitizable carbon materials and are readily graphitized by heat treatment at a high temperature, e.g., about 2800° C. Hard carbon refers to non-graphitizable carbon materials and are not substantially, and not slightly graphitized by heat treatment. The terms soft carbon and hard carbon are well known in the related arts.

In some embodiments, the crystalline carbon and the amorphous carbon may be distinguished through X-ray diffraction (XRD) measurement. The crystalline carbon includes natural graphite and artificial graphite. Natural graphite may indicate graphite that may be naturally generated by separating it from minerals, and if measured by XRD, the interplanar spacing (d002) of the (002) plane may be about 3.350 Å to about 3.360 Å. Artificial graphite may indicate graphite manufactured by graphitization, and if measured by XRD, the interplanar spacing (d002) of the (002) plane may be about 3.355 Å to about 3.365 Å. The amorphous carbon may have the interplanar spacing (d002) of the (002) plane of about 3.34 Å or less, if measured by XRD. The XRD may be measured using CuKα ray as a target line with an X-ray diffraction analyzer (e.g., product name: X'Pert, manufacturer: Malvern Panalytical) and by removing a monochromator to improve a peak density resolution. The measurement condition may be 2θ=10° to 80°, a scan speed (°/S) of 0.044 to 0.089, and a step size (°/step) of 0.013 to 0.039.

A negative active material according to one or more embodiments includes a core including a porous support, a carbon layer positioned in the pores, and a silicon layer positioned on the carbon layer; and an amorphous carbon layer on an outer surface of the core, wherein the pores include mesopores and a porosity of the mesopores is about 50% to about 100% based on 100% of the entire porosity.

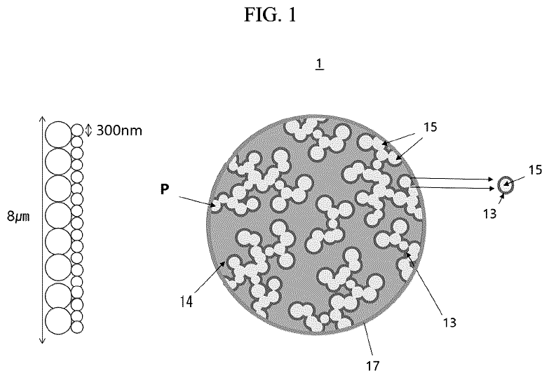

FIG. 1 schematically shows the negative active material according to one or more embodiments. As shown in FIG. 1, the negative active material 1 includes a core including the support 14 including pores, a carbon layer 13 positioned in the pores, a silicon layer 15 positioned on the carbon layer 13, and an amorphous carbon layer 17 positioned on the outer surface of the core. In FIG. 1, P indicates pores before forming the carbon layer 13 and the silicon layer 15. The size on the left of FIG. 1 schematic illustrates the size of pores.

The support according to one or more embodiments is formed with pores, and the pores have various sizes such as micropores, mesopores, or macro pores. Among these, the mesopores are included at about 50% to about 100% of the total porosity. The mesopores may have an average diameter of about 1 nm to about 50 nm. In one or more embodiments, micropores indicate pores having an average diameter less than about 1 nm and the macropores indicate pores having an average diameter greater than about 50 nm.

The mesopores may constitute about 60% to about 100%, or about 70% to about 100% of the total porosity. The average diameter of the mesopores may be about 1 nm to about 50 nm to allow for the silicon to be positioned in the mesopores. Accordingly, as silicon with the average diameter of about 1 nm to about 50 nm is positioned within the pores of the porous support, volume expansion of the silicon may be inhibited, and silicon with the average diameter of about 1 nm to about 50 nm may be appropriately included in the negative active material in proportion to a percentage of mesopores. If the mesopores are less than about 50% of the total porosity there may be an insufficient region for deposition of the silicon, and, thus, the designed capacity may be not realized.

The entire porosity of the porous support according to one or more may be about 30% to about 90%, about 40% to about 80%, or about 50% to about 70%. If the entire porosity of the porous support is within these ranges, the silicon may be included in the pores at the sufficient amount, thereby exhibiting a much higher capacity.

The entire porosity and the meso porosity of the porous support may be measured by a Barrett-Joyner-Halenda (BJH) method. For example, the porosity may be determined by measuring the pore volume by using a BJH method through N₂ absorption isotherm and dividing the measured pore volume by the volume of the entire porous support. In detail, the porous support is pre-treated by increasing a temperature to about 523 K (Kelvin, absolute temperature) at a rate of about 10 K/min and maintaining the porous support for about 2 hours to about 10 hours under the temperature and a pressure of about 100 mm Hg or less, with the liquid nitrogen of which the relative pressure (P/P0) is adjusted to about 0.01 torr or less being adsorbed by the porous support at about 32 points to the relative pressure of 0.01 torr to about 0.955 torr and desorbed at about 24 points to the relative pressure of about 0.14 torr. Given the volume of the porous support, from the amount of N₂ measured by the above method the porosity may be obtained.

In another embodiment, each porosity of the micropores, mesopores, or macro pores, and the entire porosity of the porous support may be measured by the N₂ absorption isotherm through the BJH method using the pore measurement device (ASAP2020, available from Micromeritics Instrument Corporation).

The negative active material according to embodiments is positioned in the pores of the porous support. Thus, the volume expansion of the silicon during charging and discharging may be effectively suppressed and high capacity of silicon may be obtained.

In one or more embodiments, the silicon-including porous support may include nano silicon or SiOₓ (0≤x≤2). This silicon-including porous support may provide for more uniformly deposited silicon in the pores as compared to the carbon-included porous support. Thus, smaller sized silicon may be deposited in the pores of the porous support. This enables more effective suppression of volume expansion of the silicon.

The porous support may be, based on 100 wt % of the negative active material, about 30 wt % to about 70 wt %, about 35 wt % to about 65 wt %, or about 40 wt % to about 60 wt %. If the porous support satisfies in these ranges, the amount of silicon to be deposited may be controlled, and, thus, the desired capacity may be secured.

The negative active material according to embodiments includes a carbon layer between the silicon layer positioned in the pores and the pores. Thus, enhanced ionic conductivity may be achieved.

In embodiments, the carbon layer may include amorphous carbon. The amorphous carbon may be soft carbon, hard carbon, mesophase pitch carbide, sintered coke, or combinations thereof.

In one or more embodiments, a thickness of the carbon layer may be about 1 nm to about 15 nm, about 1 nm to about 10 nm, or about 1 nm to about 5 nm. If the thickness of the carbon layer is within these ranges, the ionic conductivity may be enhanced and rate characteristics and cycle-life characteristics may be improved.

The silicon layer may include amorphous silicon. If silicon included in the silicon layer is amorphous silicon, volume expansion may be reduced during charging and discharging relative to crystalline silicon, and cycle-life characteristic also may be enhanced. In embodiments, the amorphous Si may be confirmed by measuring using TEM or XRD. In case of measuring using TEM, silicon exhibiting no crystal lattice stripes may be indicative of amorphous silicon. In case of measuring an XRD using a CuKα ray as a target ray, an appearance of broad peak may be indicative of amorphous silicon.

The silicon positioned in the pores may be elemental Si or a pure Si.

In one or more embodiments, an amount of the silicon may be, about 100 wt % of the negative active material, about 40 wt % to about 80 wt %, about 45 wt % to about 65 wt %, or about 50 wt % to about 60 wt %. If the amount of silicon is within these ranges, higher efficiency and capacity may be exhibited, and cycle-life characteristics may be excellent.

The negative active material according to one or more embodiments includes amorphous carbon positioned on the core. For example, the negative active material may include an amorphous carbon layer surrounding the outer surface of the core. The amorphous carbon layer may completely surround the surface of the core or may partially surround the surface of the core. A thickness of the amorphous carbon layer may be about 1 nm to about 100 nm, about 1 nm to about 50 nm, or about 1 nm to about 30 nm. If the thickness of the amorphous carbon layer is within these ranges, irreversible reactions may be minimized and the resistance may be enhanced.

In the amorphous carbon layer, the amorphous carbon may be pitch carbon, soft carbon, hard carbon, mesophase pitch carbide, sintered coke, carbon fiber, or combinations thereof.

Thickness of the amorphous carbon layer indicates a thickness of the amorphous carbon on the outer surface of the core, and if amorphous carbon is unevenly located, it may be a length at the thickest point. In one or more embodiments, the thickness may be an average thickness. If the thickness of the amorphous carbon coating layer is within the above-noted ranges, irreversible capacity loss may be reduced, charge and discharge efficiency may be enhanced, and rate characteristic may be enhanced.

According to embodiments, the amount of carbon may be about 1 wt % to about 30 wt %, about 1 wt % to about 20 wt %, or about 1 wt % to about 15 wt % based on 100 wt % of the negative active material. An amount of the carbon represents the sum of amounts of carbon in the carbon layer positioned in the pores and the amorphous carbon layer positioned on the core. In one or more embodiments, the entire carbon included in the negative active material is significant, and there is no need to define the amount of the carbon included in the carbon layer and the amount of the carbon included in the amorphous carbon layer.

If the amount of carbon included in the negative active material is within the above ranges, conductivity may be enhanced, thereby maximizing capacity.

In embodiments, silicon carbide may be positioned between the carbon layer and the silicon layer. In the negative active material according to one or more embodiments, the presence of the silicon carbide between the carbon layer and the silicon layer may be confirmed by X-ray diffraction. Since the silicon carbide is positioned between the carbon layer and the silicon layer, a boundary between the carbon layer and the silicon layer may be clearly identified.

A negative active material according to another embodiment includes secondary particles where at least one primary particle is agglomerated. The primary particle includes a core including a porous support including pores, a carbon layer positioned in the pores, a silicon layer positioned on the carbon layer, and an amorphous carbon layer positioned on the outer surface of the core. The pores may include mesopores and the mesopores may be about 50% to about 100%, about 60% to about 100%, or about 70% to about 100%, based on the entire porosity.

For better comprehension and ease of description, the above-described negative active material according to one embodiment refers as a negative active material according to the first embodiment and a negative active material according to another embodiment refers to a negative active material according to the second embodiment.

The negative active material according to the second embodiment includes secondary particles where the primary particles are agglomerated. Thus, the negative active material according to the second embodiment has the same configuration as the negative active material according to the first embodiment, except that it is the form of secondary particles, which are formed by agglomerating primary particles.

In one or more embodiments, the average diameters of the primary particles may be about 1 μm to about 20 μm, or about 5 μm to about 15 μm. If the size of the primary particles is within these ranges, the increase in Brunner-Emmett-Teller (BET) specific surface area may be minimized, thereby enhancing efficiency.

In the negative active material according to one or more embodiments, the size of the primary particles may be set and the size of the secondary particles may be appropriately adjusted.

If the negative active material includes secondary particles where primary particles are agglomerated, the silicon layer may be more uniformly formed on the secondary particles as compared to the negative active material according to the first embodiment, which is formed by single particles that are not agglomerated.

### [Method of Preparing Negative Active Material]

The negative active material according to one or more embodiments is prepared by a first vapor coating a carbon gas on a porous support including pores to prepare a carbon layer; a second vapor coating with a silicon gas on the carbon layer; and coating the resulting material with an amorphous carbon precursor. Hereinafter, the preparation will be described.

First, a porous support including is prepared. The porous support may be available commercially or may be formed by preparing aerogel procedure or a spray-drying procedure. In other embodiments, the porous support may be a silica gel or a zeolite.

The porous support is first vapor coated using a carbon gas. The pores of the support have various sizes such as micropore, mesopores, or macro pores. Among these, the mesopores are included at about 50% to about 100% based on the entire porosity. In one or more embodiments, the mesopores may be about 60% to about 100%, or about 70% to about 100% of the total porosity. The size of the mesopores may be about 1 nm to about 50 nm.

The entire porosity of the porous support may be about 30% to about 90%, about 40% to about 80%, or about 50% to about 70%.

The carbon gas may be a methane (CH₄) gas, an ethylene (C₂H₄) gas, an acetylene (C₂H₂) gas, a propane (C₃H₈) gas, a propylene (C₃H₆) gas, or combinations thereof.

The first vapor coating may be chemical vapor deposition process (CVD). The chemical vapor deposition may be thermal chemical vapor deposition, plasma-enhanced chemical vapor deposition, or low-pressure chemical vapor deposition.

The first vapor coating procedure may be carried out at about 300° C. to about 1200° C., e.g., about 500° C. to about 1200° C., e.g., about 600° C. to about 1150° C., or about 700° C. to about 1100° C.

In the first vapor coating, the flow rate of gas of the carbon gas may be about 0.3 L/min to about 1 L/min, or about 0.3 L/min to about 0.6 L/min. If the gas flow rate of the carbon gas is within these ranges, the carbon layer may be sufficiently formed in the pores of the porous support.

The deposition may be carried out for about 0.15 hours to about 5 hours, or about 0.15 hours to about 3 hours.

Thereafter, the second vapor coating procedure is conducted on the carbon layer using the silicon gas to prepare a silicon layer. The silicon gas may be a SiH₄ gas, a Si₂H₆ gas, a Si₃H₈ gas, or combinations thereof.

The second vapor coating process may be chemical vapor deposition (CVD). The chemical vapor deposition may be thermal chemical vapor deposition, plasma-enhanced chemical vapor deposition, or low-pressure chemical vapor deposition. The vapor deposition may be performed at a temperature at which silicon to be deposited is converted into amorphous Si, a-Si, for example, about 400° C. to about 700° C. If the second vapor deposition is performed at a temperature of more than about 700° C., silicon to be deposited is crystallized, thereby increasing the volume expansion during charge and discharge and reducing the cycle-life characteristics. If the second vapor deposition is performed at a temperature of less than about 400° C., the silicon raw material is not readily decomposed and remains as an impurity in the porous support.

In the second vapor coating, the flow rate of gas, which is the silicon source material, may be about 0.3 L/min to about 1 L/min, or about 0.3 L/min to about 0.6 L/min. If the second vapor coating is carried out by using a gas flow rate in these ranges, the silicon layer may be sufficiently formed on the carbon layer of the porous support.

The secondary vapor coating may be carried out for about 0.5 hours to about 5 hours, or about 0.5 hours to about 3 hours.

Thereafter, an amorphous carbon layer is formed on the resulting product. The formation of the amorphous carbon layer is carried out by vapor coating with an amorphous carbon precursor gas, or by mixing the resulting product with the amorphous carbon precursor and carbonizing.

The amorphous carbon precursor gas may be a methane (CH₄) gas, an ethylene (C₂H₄) gas, an acetylene (C₂H₂) gas, a propane (C₃H₈) gas, a propylene (C₃H₆) gas, or combinations thereof. The vapor coating may be carried out by a vapor deposition, and the vapor deposition may be a chemical vapor deposition. The chemical vapor deposition may be thermal chemical vapor deposition, plasma-enhanced chemical vapor deposition, or low-pressure chemical vapor deposition.

The vapor coating procedure may be carried out at about 700° C. to about 1000° C., or about 700° C. to about 900° C.

The amorphous carbon precursor may be petroleum coke, coal coke, petroleum pitch, coal pitch, meso pitch, pitch carbon, synthesized pitch, green cokes, or combinations thereof.

In case of mixing with the amorphous carbon precursor, a mixing ratio of the resulting product and the amorphous carbon precursor may be about 99:1 to about 90:10 by weight ratio, or about 99:1 to about 95:5 by weight ratio.

The carbonization may be carried out at about 600° C. to about 1,000° C., or about 700° C. to about 1,000° C. The carbonization may be carried out under a nitrogen atmosphere, helium atmosphere, or a combination thereof.

In the carbonization, the amorphous carbon precursor may be converted into an amorphous carbon, thereby preparing an amorphous carbon layer.

### <Rechargeable Lithium Battery>

Another embodiment provides a rechargeable lithium battery including a negative electrode, a positive electrode, and an electrolyte.

### [Negative Electrode]

The negative electrode includes a current collector and a negative active material layer formed on the current collector, with the negative active material layer including the negative active material according to one or more embodiments. The negative active material layer that includes the negative active material may further include a binder and a conductive material.

In the negative active material layer, an amount of the negative active material may be about 90 wt % to about 99 wt % based on the total 100 wt % of the negative active material layer. An amount of the binder may be about 1 wt % to about 5 wt % based on the total 100 wt % of the negative active material layer. If the conductive material is included, an amount of the binder may be about 0.5 wt % to about 5 wt % based on the total 100 wt % of the negative active material layer and an amount of the conductive material may be about 0.5 wt % to about 5 wt % based on the total 100 wt % of the negative active material layer.

The binder improves binding properties of negative active material particles with one another and with a current collector. The binder may be a non-aqueous binder, an aqueous binder, a dry binder or combination thereof.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or combinations thereof.

The aqueous binder may be a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, or combinations thereof.

If the aqueous binder is used as a negative electrode binder, a cellulose-based compound may be further used to provide viscosity. The cellulose-based compound includes one or more of carboxymethyl cellulose, hydroxypropylmethyl cellulose, methyl cellulose, or alkali metal salts thereof. The alkali metal may be Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or combinations thereof.

The conductive material is included to provide electrode conductivity, and any electrically conductive material may be used provided that it does not cause a chemical change. Examples of the conductive material may be a carbon-based material such as natural graphite, artificial graphite, carbon black, acetylene black, ketjen black, a carbon fiber, a carbon nanofiber, carbon nanotube, or the like; a metal-based material of a metal powder or a metal fiber including copper, nickel, aluminum, silver, or the like; a conductive polymer such as a polyphenylene derivative; or a mixture thereof.

The negative current collector may be selected from a copper foil, a nickel foil, a stainless-steel foil, a titanium foil, a nickel foam, a copper foam, a polymer substrate coated with a conductive metal, and combinations thereof.

### [Positive Electrode]

The positive electrode may include a current collector and a positive active material layer on the current collector. The positive active material layer includes a positive active material and may further include a binder and/or a conductive material.

The positive electrode may further include an additive that serves as a sacrificial positive electrode.

An amount of the positive active material may be, about 90 wt % to about 99.5 wt % based on 100 wt % of the positive active material layer. Amounts of the binder and the conductive material may be respectively 0.5 wt % to 5 wt % based on 100 wt % of the positive active material layer.

The positive active material may include a compound (lithiated intercalation compound) that is capable of intercalating and deintercalating lithium. In some embodiments, at least one of a composite oxide of lithium and a metal selected from cobalt, manganese, nickel, or combinations thereof may be used. The composite oxide may be a lithium transition metal composite oxide, and examples thereof may include lithium nickel-based oxide, lithium cobalt-based oxide, lithium manganese-based oxide, lithium iron phosphate-based compound, cobalt-free nickel-manganese-based oxide, or a combination thereof.

For example, the following compounds represented by any one of the following chemical formulas may be used as the composite oxide: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<α<2); LiₐNi_{1-b-c}Mn_{b}X_{c}O₂−αD_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≥0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8). In the chemical formulas, A is Ni, Co, Mn, or combinations thereof; X is Al, Ni, Co, Mn, Cr, Fe, Mg, Sr, V, a rare earth element or combinations thereof; D is O, F, S, P, or combinations thereof; G is Al, Cr, Mn, Fe, Mg, La, Ce, Sr, V, or combinations thereof; and L¹ is Mn, Al, or combinations thereof.

The positive active material may be nickel-based positive active material having a nickel amount of greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of the metal excluding lithium in the lithium transition metal composite oxide. The high-nickel-based positive active material have high capacity and may be used in a high-capacity, high-density rechargeable lithium battery.

The binder improves binding properties of positive electrode active material particles with one another and with a current collector. Examples of the binder are polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene butadiene rubber, a (meth)acrylated styrene butadiene rubber, an epoxy resin, a (meth)acrylic resin, a polyester resin, nylon, or the like. But the present disclosure is not limited to such examples.

The conductive material is included to provide electrode conductivity, and any electrically conductive material may be used provided that it does not cause a chemical change. Examples of the conductive material include a carbonaceous material such as natural graphite, artificial graphite, carbon black, acetylene black, Ketjen black, carbon fiber, carbon nanofiber, carbon nanotube, or the like; a metal-based material of a metal powder or a metal fiber including copper, nickel, aluminum, silver, or the like; a conductive polymer such as a polyphenylene derivative; or a mixture thereof.

The current collector may include Al, but is not limited thereto.

### [Electrolyte]

The electrolyte includes a non-aqueous organic solvent and a lithium salt.

The non-aqueous organic solvent serves as a medium for transmitting ions taking part in the electrochemical reaction of a battery. The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like.

The ester-based solvent may include methyl acetate, ethyl acetate, n-propyl acetate, dimethyl acetate, methyl propionate, ethyl propionate, decanolide, mevalonolactone, valerolactone, caprolactone, or the like.

The ether-based solvent may include dibutyl ether, tetraglyme, diglyme, dimethoxyethane, 2-methyltetrahydrofuran, 2,5-dimethyltetrahydrofuran, tetrahydrofuran, or the like. The ketone-based solvent may include cyclohexanone, or the like. The alcohol-based solvent may include ethanol, isopropyl alcohol, or the like and the aprotic solvent may include nitriles such as R—CN (wherein R is a C2 to C20 linear, branched, or cyclic hydrocarbon group, and may include a double bond, an aromatic ring, or an ether bond, or the like); amides such as dimethylformamide; dioxolanes such as 1,3-dioxolane, 1,4-dioxolane, or the like; sulfolanes, or the like.

The non-aqueous organic solvent may be used alone or in a mixture of two or more.

If a carbonate-based solvent is used, cyclic carbonate and linear carbonate may be used together, and the cyclic carbonate and the linear carbonate may be mixed at a volume ratio of about 1:1 to about 1:9.

The lithium salt dissolved in an organic solvent supplies a battery with lithium ions, operates the rechargeable lithium battery and improves transportation of the lithium ions between positive and negative electrodes. Examples of the lithium salt include one or more supporting electrolyte salts selected from LiPF₆, LiBF₄, LiSbF₆, LiAsF₆, LiClO₄, LiAlO₂, LiAlCl₄, LIPO₂F₂, LiCl, LiI, LiN(SO₃C₂F₅)₂, Li(FSO₂)₂N (lithium bis(fluorosulfonyl)imide, LiFSI), LiC₄F₉SO₃, LIN(CₓF₂ₓ₊₁SO₂)(C_{y}F_{2y+1}SO₂), where x and y are an integer of 1 to 20, lithium trifluoromethane sulfonate, lithium tetrafluoroethane sulfonate, lithium difluorobis(oxalato)phosphate (LiDFOP), and lithium bis(oxalato) borate (LiBOB).

### [Separator]

A separator may be disposed between the positive electrode and the negative electrode depending on a type of a rechargeable lithium battery. The separator be formed from polyethylene, polypropylene, polyvinylidene fluoride or multi-layers thereof having two or more layers and may be a mixed multilayer polyethylene/polypropylene double-layered separator, a such as a polyethylene/polypropylene/polyethylene triple-layered separator, a polypropylene/polyethylene/polypropylene triple-layered separator, or the like.

The separator may include a porous substrate and a coating layer including an organic material, an inorganic material, or a combination thereof on one or both surfaces of the porous substrate. The porous substrate may be a polymer film formed of any one selected from polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acryl-based polymer.

The inorganic material may be an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof. But the present disclosure is not limited to these examples.

The organic material and an inorganic material may be mixed in one coating layer, or a coating layer including an inorganic material may be stacked.

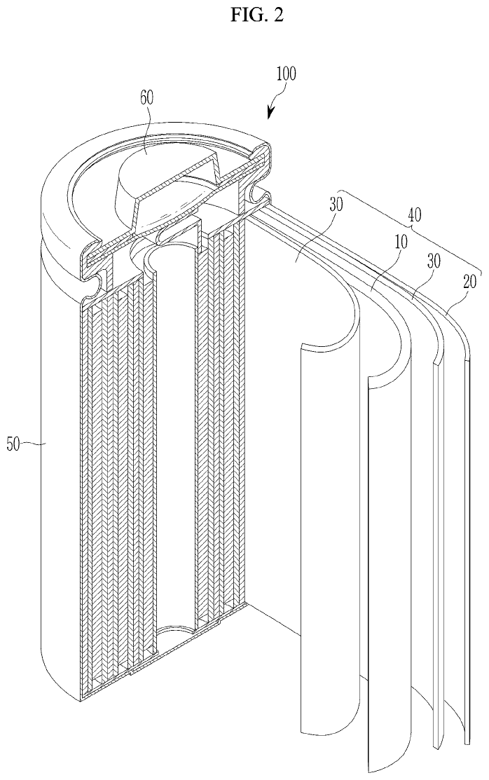

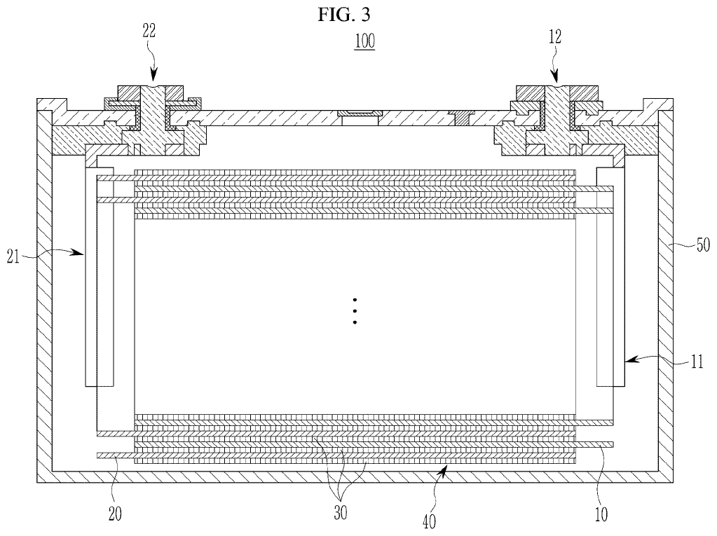

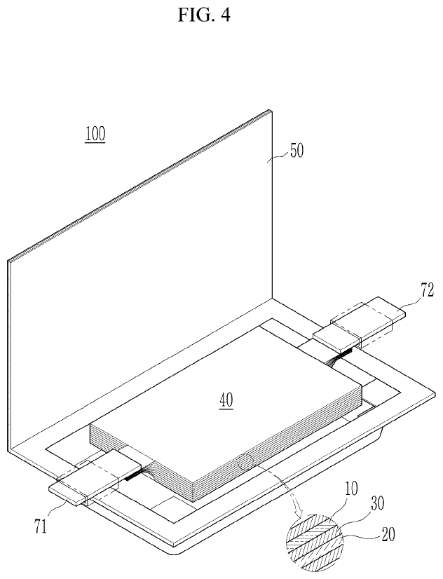

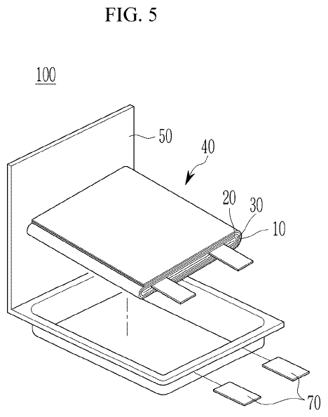

The rechargeable lithium battery may be classified as cylindrical, prismatic, pouch, or coin-type, or the like depending on its shape. FIG. 2 to FIG. 5 are schematic views illustrating a rechargeable lithium battery according to embodiments. FIG. 2 shows a cylindrical battery, FIG. 3 shows a prismatic battery, and FIG. 4 and FIG. 5 show pouch-type batteries. The rechargeable lithium battery 100 may include an electrode assembly 40 including a separator 30 between a positive electrode 10 and a negative electrode 20, and a case 50 in which the electrode assembly 40 is accommodated. The positive electrode 10, the negative electrode 20, and the separator 30 may be impregnated with an electrolyte (not shown). The rechargeable lithium battery 100 may include a sealing member 60 sealing the case 50, as shown in FIG. 2. As shown in FIG. 3, the rechargeable lithium battery 100 may include a positive electrode lead tab 11, a positive terminal 12, a negative electrode lead tab 21, and a negative terminal 22. As shown in FIG. 4 and FIG. 5, the rechargeable lithium battery 100 may include an electrode tab 70, which may form an electrical path for inducing the current formed in the electrode assembly 40 to outside of the battery. The electrode tab 70 may include a positive electrode tab 71 and a negative electrode tab 72.

The rechargeable lithium battery according to an embodiment may be used in automobiles, mobile phones, and/or various types of electric devices, as non-limiting examples.

The following Examples and Comparative Examples are provided in order to highlight characteristics of one or more embodiments, but it will be understood that the Examples and Comparative Examples do not limit the scope of the embodiments. Nor are the Comparative Examples to be construed as being outside the scope of the embodiments. Further, it will be understood that the embodiments are not limited to the particular details described in the Examples and Comparative Examples.

### Example 1

A chemical vapor deposition (first deposition) was conducted on a SiO₂ porous support having a total porosity of 60%, 95% of the porosity being mesopores (10 nm to 50 nm in average diameter) using a methane (CH₄) gas at 950° C. to thereby prepare a soft carbon layer in the pores. In the chemical vapor deposition, the gas flow rate of the methane gas was 0.3 L/mi and the chemical vapor deposition was carried out for 0.15 hours.

The porosity was measured by the BJH method (N₂ absorption isotherm) using a porosimeter (ASAP2020, Micromeritics Instruments Corporation).

The thickness of the soft carbon formed in the pores was 1 nm.

Thereafter, a chemical vapor deposition process (second deposition) using a SiH₄ gas was carried out on the soft carbon layer at 500° C., to prepare an amorphous silicon layer in the pores. In the chemical vapor deposition, the flow rate of the SiH₄ gas was 0.3 L/min and the chemical vapor deposition was carried out for 1 hours.

The resulting product was provided with a petroleum pitch at a 99:1 weight ratio and was carbonized at 1000° C. to prepare a negative active material.

The prepared negative active material included the core having the soft carbon layer provided in the pores of the porous support, and the silicon layer provided on the soft carbon layer, and the soft carbon layer provided on the outer surface of the core. The core also included the silicon carbide provided between the soft carbon layer and the silicon layer. The thickness of the soft carbon layer provided in the pores was 1 nm and the thickness of the soft carbon layer provided on the outer surface of the core was 10 nm. Based on 100 wt % of the prepared negative active material, an amount of the SiO₂ porous support was 42 wt %, an amount of the amorphous silicon was 55 wt %, and an amount of the soft carbon was 3 wt %. It was confirmed by XRD using the CuKα ray that the silicon was amorphous in the prepared negative active material.

97.5 wt % of the prepared negative active material, 1.5 wt % of carboxymethyl cellulose, and 1 wt % of a styrene butadiene rubber were mixed in a water solvent to prepare a negative active material layer slurry.

The negative active material layer slurry was coated on a Cu foil current collector, dried, and pressurized under a general procedure to prepare a negative active material layer. Thus, a negative electrode was prepared.

96 wt % of a LiNi_{0.8}Co_{0.1}Mn_{0.1}O₂ positive active material, 2 wt % of a ketjen black, and 2 wt % of polyvinylidene fluoride were mixed in an N-methyl pyrrolidone solvent to prepare a positive active material layer slurry.

The positive active material slurry was coated on an Al foil current collector, dried, and pressurized to prepare a positive electrode.

Using general procedures, a half-cell was fabricated with the negative electrode, a lithium metal counter electrode, and an electrolyte. And using the negative electrode, the positive electrode, and an electrolyte, a full cell was fabricated by the general procedures.

In the half-cell and full cell, 1M LiPF₆ dissolved in a mixed solvent of ethylene carbonate and dimethyl carbonate (3:7 volume ratio) was used as the electrolyte.

### Example 2

A negative active material was prepared by the same procedure as in Example 1, except that the first deposition was carried out for 0.3 hours and the second deposition was carried out for 1 hour. In the prepared negative active material, a thickness of the soft carbon layer positioned in the pores was 2 nm. An amount of the SiO₂ porous support was 42 wt %, an amount of the amorphous silicon was 53 wt %, and amount of the soft carbon was 5 wt %, based on 100 wt % of the prepared negative active material.

A half-cell and a full cell were fabricated by the same procedure as in Example 1, except for the negative active material.

### Example 3

A negative active material was prepared by the same procedure as in Example 1, except that the first deposition was carried out for 0.4 hours and the second deposition was carried out for 1 hour. In the prepared negative active material, a thickness of the soft carbon layer positioned in the pores was 3 nm. An amount of the SiO₂ porous support was 42 wt %, an amount of the amorphous silicon was 51 wt %, and amount of the soft carbon was 7 wt %, based on 100 wt % of the prepared negative active material.

A half-cell and a full cell were fabricated by the same procedure as in Example 1, except for the negative active material.

### Example 4

A negative active material was prepared by the same procedure as in Example 1, except that the first deposition was carried out for 0.7 hours and the second deposition was carried out for 1 hour. In the prepared negative active material, a thickness of the soft carbon layer positioned in the pores was 5 nm. An amount of the SiO₂ porous support was 42 wt %, an amount of the amorphous silicon was 46 wt %, and amount of the soft carbon was 12 wt %, based on 100 wt % of the prepared negative active material.

A half-cell and a full cell were fabricated by the same procedure as in Example 1, except for the negative active material.

### Comparative Example 1

A negative active material was prepared by the same procedure as in Example 1 except that the SiO₂ porous support had a porosity of 40% and micropores (less than 1 nm in average diameter) constituted 70% of the total porosity. In the prepared negative active material, a thickness of the soft carbon layer positioned in the pores was 1 nm. An amount of the SiO₂ porous support was 55 wt %, an amount of the amorphous silicon was 42 wt %, and amount of the soft carbon was 3 wt %, based on 100 wt % of the prepared negative active material.

A half-cell and a full cell were fabricated by the same procedure as in Example 1, except for the negative active material.

### Comparative Example 2

A negative active material was prepared by the same procedure as in Example 1 except that the SiO₂ porous support had a porosity of 80% and macropores (larger than 50 nm in average diameter) constituted 70% of the total porosity. The first deposition was carried out for 3 hours, and the second deposition was carried out for 1 hour. In the prepared negative active material, a thickness of the soft carbon layer positioned in the pores was 20 nm. An amount of the SiO₂ porous support was 15 wt %, an amount of the amorphous silicon was 42 wt %, and amount of the soft carbon was 43 wt %, based on 100 wt % of the prepared negative active material.

A half-cell and a full cell were fabricated by the same procedure as in Example 1, except for the negative active material.

### Comparative Example 3

A negative active material was prepared by the same procedure as in Example 1 except that a chemical vapor deposition process using a SiH₄ gas was carried out at 500° C. in the SiO₂ porous support having a porosity of 60% and mesopores (average diameters of 10 nm to 50 nm) constituted 95% of the porosity. In the chemical vapor deposition, the flow rate of the SiH₄ gas was 0.3 L/min and the chemical vapor deposition was carried out for 1 hours.

The resulting product was added to a petroleum pitch at a 99:1 weight ratio (i.e., a weight ratio of the resulting product to the petroleum pitch is 99:1) and carbonized at 1000° C. to prepare a negative active material.

The prepared negative active material included the core with the silicon layer provided in the pores of the porous support and the soft carbon layer was provided on the outer surface of the core. Also, a silicon carbide was provided between the soft carbon layer and the silicon layer. Based on 100 wt % of the prepared negative active material, an amount of the SiO₂ porous support was 42 wt %, an amount of the amorphous silicon was 57 wt %, and an amount of the soft carbon was 1 wt %.

A half-cell and a full cell were fabricated by the same procedure as in Example 1, except for the negative active material.

### Comparative Example 4

A negative active material was prepared by the same procedure as in Example 1, except that the first deposition was carried out for 1.8 hours and the second deposition was carried out for 1 hour. In the prepared negative active material, a thickness of the soft carbon layer provided in the pores was 20 nm. Based on 100 wt % of the prepared negative active material, an amount of the SiO₂ porous support was 42 wt %, an amount of the amorphous silicon was 36 wt %, and amount of the soft carbon was 22 wt %.

A half-cell and a full cell were fabricated by the same procedure as in Example 1, except for the negative active material.

### Comparative Example 5

A negative active material was prepared by the same procedure as in Example 1, except that the first deposition was carried out for 3 hours and the second deposition was carried out for 1 hour. In the prepared negative active material, a thickness of the soft carbon layer provided in the pores was 30 nm. Based on 100 wt % of the prepared negative active material, an amount of the SiO₂ porous support was 42 wt %, an amount of the amorphous silicon was 15 wt %, and amount of the soft carbon was 43 wt %.

A half-cell and a full cell were fabricated by the same procedure as in Example 1, except for the negative active material.

### Comparative Example 6

Nano silicon and a petroleum pitch were mixed with a weight ratio of 60:40, and the mixture was carbonized at 950° C. to prepare a negative active material.

The prepared negative active material included a core comprising nano silicon and a soft carbon layer positioned on the surface thereof. A silicon carbide was provided between the soft carbon layer and the silicon layer. An amount of soft carbon was 40 wt % based 100 wt % of the prepared negative active material.

A half-cell and a full cell were fabricated by the same procedure as in Example 1, except for the negative active material.

### Experimental Example 1) Evaluation of Specific Capacity

The half-cells according to Examples 1 to 4 and Comparative Examples 1 to 6 were charged and discharged once at 0.1 C to measure a specific capacity. The results are shown in Table 1.

### Experimental Example 2) Evaluation of Efficiency

The full cells according to Examples 1 to 4 and Comparative Examples 1 to 6 were charged and discharged once at 0.1 C. and a ratio of the measured discharge capacity relative to the measured charge capacity was obtained. The results are shown in Table 1 as efficiency %.

### Experimental Example 3) Evaluation of Chargeability

The full cells according to Examples 1 to 4 and Comparative Examples 1 to 6 were charged and discharged once at 0.2 C and charged and discharged once at 2.0 C and ratios of the discharge capacity at 2.0 C relative to discharge capacity at 0.2 C were obtained. The results are shown in Table 1 as chargeability %.

### Experimental Example 4) Evaluation of Cycle-Life Characteristic

The full cells according to Examples 1 to 4 and Comparative Examples 1 to 6 were charged and discharged at 1 C for 400 cycles. A ratio of capacity at each cycle relative to the discharge capacity at the first cycle was calculated. The number of cycles where the ratio of capacity (capacity retention) reached 80% is shown in Table 1, labeled as the number of cycles at which cycle-life sharply decreased.

TABLE 1

| | | | | Cycle number at |
|---|---|---|---|---|
| | Specific | | | which cycle-life |
| | capacity | Efficiency | Chargeability | sharply |
| | (mAh/g) | (%) | (%) | decreased (No.) |
| Example 1 | 1980 | 90.5 | 46 | 900 |
| Example 2 | 1910 | 90.3 | 47 | 950 |
| Example 3 | 1840 | 90.1 | 49 | 950 |
| Example 4 | 1710 | 89.9 | 50 | 940 |
| Comparative | 1520 | 89.8 | 42 | 500 |
| Example 1 | | | | |
| Comparative | 1630 | 85 | 46 | 100 |
| Example 2 | | | | |
| Comparative | 2055 | 89 | 40 | 650 |
| Example 3 | | | | |
| Comparative | 1350 | 86 | 46 | 700 |
| Example 4 | | | | |
| Comparative | 646 | 85 | 46 | 700 |
| Example 5 | | | | |
| Comparative | 1700 | 87.1 | 44 | 600 |
| Example 6 | | | | |

As shown in Table 1, Examples 1 to 4 exhibited high specific capacity and improved efficiency and chargeability, and Examples 1 to 4 also had excellent cycle-life characteristics.

Comparative Examples 1 and 2 using the porous support mostly composed of micropores or macropores exhibited very low specific capacity, slightly low efficiency and chargeability, and very deteriorated cycle-life characteristics. In particular, Comparative Example 2 using the porous support mostly composed of macropores exhibited extremely deteriorated cycle-life characteristic as capacity retention abruptly decreased to 80%.

Comparative Example 3 without the carbon layer in the pores exhibited abruptly low chargeability and cycle-life characteristic.

Comparative Examples 4 and 5 in which the thickness of the soft carbon layer was thick, exhibited very low specific capacity, efficiency, cycle-life characteristic.

Comparative Example 6 using the negative active material including nano silicon core, the soft carbon layer, and silicon carbide, exhibited slightly low specific capacity, efficiency, and chargeability, and significantly low cycle-life characteristic.

While this disclosure has been described in connection with what is presently considered to be practical example embodiments, it is not limited to the disclosed embodiments. Rather, it covers various modifications and equivalent arrangements.

What is claimed is:

1. A negative active material comprising:
a core comprising a porous support comprising pores, a carbon layer provided in the pores, and a silicon layer provided on the carbon layer, and
an amorphous carbon layer provided on an outer surface of the core,
wherein the pores comprise mesopores that are about 50% to about 100% of a total porosity of the porous support.

2. The negative active material as claimed in claim 1, wherein the carbon layer comprises amorphous carbon, crystalline carbon, or a combination thereof.

3. The negative active material as claimed in claim 1, wherein the carbon layer comprises amorphous carbon.

4. The negative active material as claimed in claim 1, wherein the silicon layer comprises amorphous silicon.

5. The negative active material as claimed in claim 1, wherein an average diameter of the mesopores is about 1 nm to about 50 nm.

6. The negative active material as claimed in claim 1, wherein the total porosity of the porous support is about 30% to about 90%.

7. The negative active material as claimed in claim 1, wherein an amount of the silicon is about 40 wt % about 80 wt % based on 100 wt % of the negative active material.

8. The negative active material as claimed in claim 1, wherein the carbon layer has a thickness of about 1 nm to about 15 nm.

9. The negative active material as claimed in claim 1, wherein the porous support comprises nano silicon or SiOₓ (0≤x≤2).

10. The negative active material as claimed in claim 1, further comprising silicon carbide provided between the carbon layer and the silicon layer.

11. A negative active material comprising:
secondary particles that are an agglomeration of primary particles,
wherein the primary particles comprising a core comprising (i) a porous support comprising pores, (ii) a carbon layer provided in the pores, (iii) a silicon layer provided on the carbon layer, and (iv) an amorphous carbon layer provided on an outer surface of the core, and
wherein the pores comprise mesopores that are about 50% to about 100% of a total porosity of the porous support.

12. The negative active material as claimed in claim 11, wherein the carbon layer comprises amorphous carbon, crystalline carbon, or a combination thereof.

13. The negative active material as claimed in claim 11, wherein the carbon layer comprises amorphous carbon.

14. The negative active material as claimed in claim 11, wherein the silicon layer comprises amorphous silicon.

15. The negative active material as claimed in claim 11, wherein an average diameter of the mesopores is about 1 nm to about 50 nm.

16. The negative active material as claimed in claim 11, wherein the total porosity of the porous support is about 30% to about 90%.

17. The negative active material as claimed in claim 11, wherein an amount of the silicon is about 40 wt % about 80 wt % based on 100 wt % of the negative active material.

18. The negative active material as claimed in claim 11, wherein the carbon layer has a thickness of about 1 nm to about 15 nm.

19. The negative active material as claimed in claim 11, wherein the porous support comprises nano silicon or SiOₓ (0≤x≤2).

20. The negative active material as claimed in claim 11, further comprising silicon carbide provided between the carbon layer and the silicon layer.

21. A method of preparing a negative active material, comprising:
first vapor coating on a porous support comprising pores with a carbon gas to form a carbon layer in the pores;
second vapor coating on the carbon layer with a silicon gas to form a silicon layer; and
coating an outer surface of the porous support with an amorphous carbon precursor,
wherein the pore comprises mesopores that are about 50% to about 100% of a total porosity of the porous support.

22. The method of preparing the negative active material as claimed in claim 21, wherein an average diameter of the mesopores is about 1 nm to about 50 nm.

23. The method of preparing the negative active material as claimed in claim 21, wherein the total porosity of the porous support is about 30% to about 90%.

24. The method of preparing the negative active material as claimed in claim 21, wherein the carbon gas comprises methane (CH₄) gas, ethylene (C₂H₄) gas, acetylene (C₂H₂) gas, propane (C₃H₈) gas, propylene (C₃H₆) gas, or a combination thereof.

25. The method of preparing the negative active material as claimed in claim 21, wherein the silicon gas is a SiHA₄ gas, a Si₂H₆ gas, a Si₃H₈ gas, or a combination thereof.

26. The method of preparing the negative active material as claimed in claim 21, wherein the first and the second vapor coating are carried out by chemical vapor deposition.

27. The method of preparing the negative active material as claimed in claim 21, wherein the first vapor coating is carried out at about 300° C. to about 1200° C., and the second vapor coating is carried out at about 400° C. to about 700° C.

28. The method of preparing the negative active material as claimed in claim 21, wherein the amorphous carbon precursor comprises petroleum coke, coal coke, petroleum pitch, coal pitch, meso pitch, pitch carbon, synthesized pitch, green cokes, or a combination thereof.

29. A rechargeable lithium battery comprising:
a negative electrode comprising the negative active material of claim 1;
a positive electrode; and
an electrolyte.

30. A rechargeable lithium battery comprising:
a negative electrode comprising the negative active material of claim 11;
a positive electrode; and
an electrolyte.
